(19) United States
(12) Patent Application Publication
(10) Pub. No.: US 2026/0039708 A1
(43) Pub. Date: Feb. 5, 2026

(54) AUTOMATICALLY CONFIGURING APPLICATION PROGRAMMING INTERFACES FOR NETWORK SERVICES

(71) Applicant: AT&T Intellectual Property I, L.P., Atlanta, GA (US)

(72) Inventors: Dominic Ricciardi, Bridgewater, NJ (US); Christina Cacioppo, Freehold, NJ (US); Patrick Hendricks, Carrollton, GA (US); Satyendra Tripathi, Marlboro, NJ (US)

(21) Appl. No.: 18/793,171

(22) Filed: Aug. 2, 2024

(51) Int. Cl. H04L 67/02; H04L 67/51

(52) U.S. Cl. CPC H04L 67/02; G06F 8/36; H04L 67/51

(57) ABSTRACT

A method for automatically configuring application programming interfaces for network services includes receiving, via a user interface, a user input relating to a new network service, identifying, based on the user input, an application programming interface that is required for the new network service, retrieving, from a repository, an application programming interface template that is configurable to function as the application programming interface, and configuring the application programming interface template with service logic to support the new network service.

The present disclosure relates generally to software development, and relates more particularly to devices, non-transitory computer-readable media, and methods for automatically configuring application programming interfaces for network services.

### BACKGROUND

An application programming interface (API) is a type of software interface that allows two or more different computer programs or systems to communicate. One particular type of API, known as a web API, facilitates communications between computers that are connected via the Internet. Advances in APIs have more recently led to an increase in the use of microservices, a variant of service-oriented architecture in which loosely coupled services are accessed through public APIs. Microservices allow software developers to efficiently develop and deploy their own services, using off-the-shelf services.

### SUMMARY

In one example, the present disclosure describes a device, computer-readable medium, and method for automatically configuring application programming interfaces for network services. For instance, in one example, a method performed by a processing system including at least one processor includes receiving, via a user interface, a user input relating to a new network service, identifying, based on the user input, an application programming interface that is required for the new network service, retrieving, from a repository, an application programming interface template that is configurable to function as the application programming interface, and configuring the application programming interface template with service logic to support the new network service.

In another example, a non-transitory computer-readable medium stores instructions which, when executed by the processing system, cause the processing system to perform operations. The operations include receiving, via a user interface, a user input relating to a new network service, identifying, based on the user input, an application programming interface that is required for the new network service, retrieving, from a repository, an application programming interface template that is configurable to function as the application programming interface, and configuring the application programming interface template with service logic to support the new network service.

In another example, a system includes a processing system including at least one processor and a non-transitory computer-readable medium storing instructions which, when executed by the processing system, cause the processing system to perform operations. The operations include receiving, via a user interface, a user input relating to a new network service, identifying, based on the user input, an application programming interface that is required for the new network service, retrieving, from a repository, an application programming interface template that is configurable to function as the application programming interface, and configuring the application programming interface template with service logic to support the new network service.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure for automatically configuring application programming interfaces for network services may operate;

FIG. 2 illustrates a flowchart of an example method for automatically configuring application programming interfaces for network services, according to the present disclosure; and

FIG. 3 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure provides a system, method, and non-transitory computer readable medium for automatically configuring application programming interfaces for network services. As discussed above, a web API facilitates communications between computers that are connected via the Internet. Advances in APIs have more recently led to an increase in the use of microservices, a variant of service-oriented architecture in which loosely coupled services are accessed through public APIs. Microservices allow software developers to efficiently develop and deploy their own services, using off-the-shelf services.

A communications service provider may support a variety of different business units and customers, including mobility, Internet of Things (IoT), broadband, and others. Often, these business units and customers may build microservices that utilize the same or similar APIs to perform the same or similar functions. However, currently, there is no way to reuse APIs that are part of existing microservices in new microservices that are being developed. Thus, if the individuals who are responsible for developing the new microservices do not possess at least a certain level of expertise in configuring APIs, the development process may be error prone and time consuming, delaying time to market.

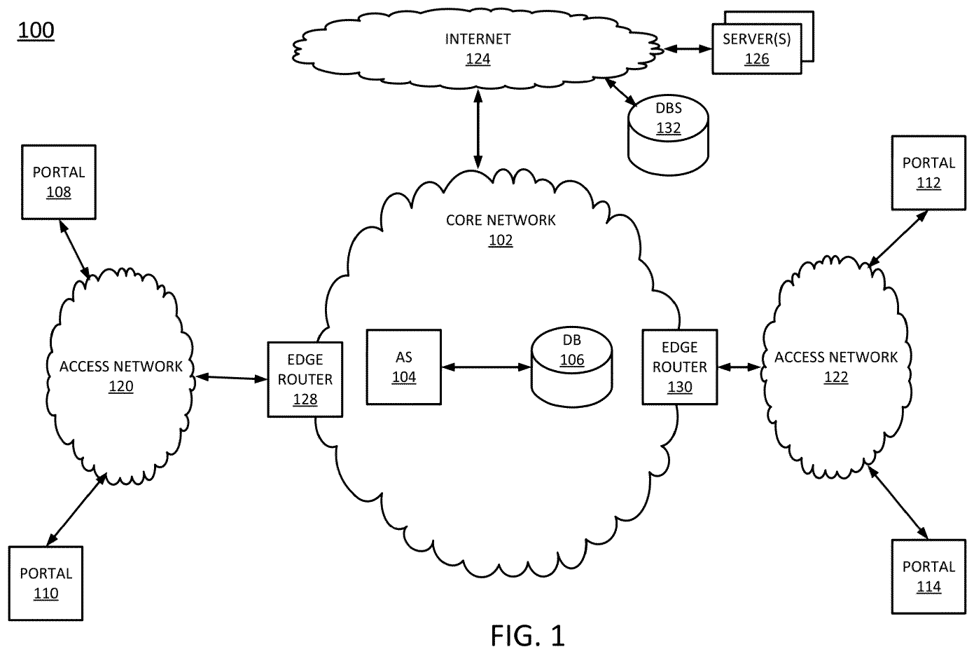

Examples of the present disclosure provide a service development toolkit that includes application logic for calling the APIs required to support a new network service (e.g., a microservice) and for configuring the APIs to support the new network service. The service development toolkit allows APIs to be reused across different types of services, which will speed up service development and time to market. Examples of the service development toolkit expose a simplified user interface that allows a user to onboard the new network service with the required APIs without requiring the user to possess expertise in configuring and orchestrating APIs. These and other aspects of the present disclosure are discussed in further detail with reference to FIGS. 1-3, below.

To further aid in understanding the present disclosure, FIG. 1 illustrates an example system 100 in which examples of the present disclosure for automatically configuring application programming interfaces for network services may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wired network, a wireless network, and/or a cellular network (e.g., 2G-5G, a long term evolution (LTE) network, 6G or any other future generations of network technology, and the like) related to the current disclosure. It should be noted that an IP network is broadly defined as a network that uses Internet Protocol to exchange data packets. Additional example IP networks include Voice over IP (VoIP) networks, Service over IP (SoIP) networks, the World Wide Web, and the like.

In one example, the system 100 may comprise a core network 102. The core network 102 may be in communication with one or more access networks 120 and 122, and with the Internet 124. In one example, the core network 102 may functionally comprise a fixed mobile convergence (FMC) network, e.g., an IP Multimedia Subsystem (IMS) network. In addition, the core network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. In one example, the core network 102 may include at least one application server (AS) 104, at least one database (DB) 106, and a plurality of edge routers 128-130. For ease of illustration, various additional elements of the core network 102 are omitted from FIG. 1.

In one example, the access networks 120 and 122 may comprise Digital Subscriber Line (DSL) networks, public switched telephone network (PSTN) access networks, broadband cable access networks, Local Area Networks (LANs), wireless access networks (e.g., an IEEE 802.11/Wi-Fi network and the like), cellular access networks, 3^{rd} party networks, and the like. For example, the operator of the core network 102 may provide a cable television service, an IPTV service, or any other types of telecommunication services to subscribers via access networks 120 and 122. In one example, the access networks 120 and 122 may comprise different types of access networks, may comprise the same type of access network, or some access networks may be the same type of access network and other may be different types of access networks. In one example, the core network 102 may be operated by a telecommunication network service provider (e.g., an Internet service provider, or a service provider who provides Internet services in addition to other telecommunication services). The core network 102 and the access networks 120 and 122 may be operated by different service providers, the same service provider or a combination thereof, or the access networks 120 and/or 122 may be operated by entities having core businesses that are not related to telecommunications services, e.g., corporate, governmental, or educational institution LANs, and the like.

In one example, the access network 120 may be accessible via one of more web portals 108 and 110. Similarly, the access network 122 may be accessible via one of more web portals 112 and 114. The access networks 120 and 122 may transmit and receive communications between user endpoint devices connected to the web portals 108, 110, 112, and 114, between the user endpoint devices, the server(s) 126, the AS 104, other components of the core network 102, devices reachable via the Internet in general, and so forth. In one example, the web portals 108, 110, 112, and 114 may comprise the access points via which different groups of users access the AS 104, other components of the core network 102, devices reachable via the Internet in general, and so forth, to configure APIs for new network services being developed by the users. Thus, one web portal may comprise a customer portal (e.g., for customers of an enterprise that provides the services for automatically configuring application programming interfaces for network services), an internal portal (e.g., for employees of the enterprise), a customer support portal (CSP), or a portal for another group of users.

In one example, one or more servers 126 and one or more databases 132 may be accessible via the portals 108, 110, 112, and 114 via Internet 124 in general. In one example, at least some of the servers 126 and DBs 132 host applications that include software development toolkits. In a further example, at least some of the software development toolkits include functionality for automatically configuring application programming interfaces for network services. For instance, the DBs 132 may store prepositioned application programming interface and/or software development toolkit service enablers, such as reusable service building blocks and application programming interface templates.

In accordance with the present disclosure, the AS 104 may be configured to provide one or more operations or functions in connection with examples of the present disclosure for automatically configuring application programming interfaces for network services, as described herein. For instance, in one example, the AS 104 may provide applications that include software development toolkits, where these applications may be accessible to users via one or more of the portals 108, 110, 112, and 114. In one example, one or more of the edge routers 128 and 130 may function as an application programming interface gateway that cooperates with the AS 104 to perform functions including access and authentication, onboarding, service level agreement enforcement, and the like.

In one example, the portals 108, 110, 112, and 114 may present user interfaces to respective users, where the user interfaces may be configured to allow the users to interact with a software development toolkit and to build new network services (or new features of existing network services) by using prepositioned application programming interface and software development kit service enablers. In one example, the user interface may comprise a drag and drop interface that allows the users to easily search and configure reusable service building blocks and application programming interface templates.

In one example, when the AS 104 receives a user input relating to a new network service, the AS 104 may identify, based on the user input, an application programming interface that is required for the new network service. For instance, where the new network service may comprise a feature of an online gaming application that allows a user to temporarily upgrade their 5G network connection to reduce latency, the feature may require an application programming interface that communicates with the subscription and billing services of a 5G network operator.

In one example, the AS 104 may retrieve an application programming interface template from the DB 106. The DB 106 may store a plurality of application programming interface templates. At least some of the application programming interface templates may comprise generic templates for communicating with a particular type of application or operating system. A generic template of this type may be configured with specific values or data to facilitate communication of specific data to and/or from a specific application or operating system. In a further example, at least some of the DBs 106 may store a plurality of application programming interface templates. At least some of the application programming interface templates may comprise application programming interfaces that have been used in existing services and may be reused to facilitate similar functions in new services.

The AS 104 may configure parameters of the application programming interface with specific values provided by a user. When configured with these specific values and properly orchestrated, the application programming interface template may generate a functioning application programming interface that is capable of supporting the new network service. For instance, an application programming interface template for an application programming interface that communicates with the subscription and billing services of a 5G network operator may be configured with service logic and values that generate an application programming interface that facilitates communications between the subscription and billing services and an online gaming application.

Once the AS 104 has configured the application programming interface with the service logic and values to support the new network service, a provider of the new network service may deploy the new network service for use. For instance, once communications between the subscription and billing services of a 5G network operator and an online gaming application are facilitated, the online gaming application may be able to offer users the opportunity to upgrade their 5G network service, at least on a temporary basis, to improve their gaming experiences.

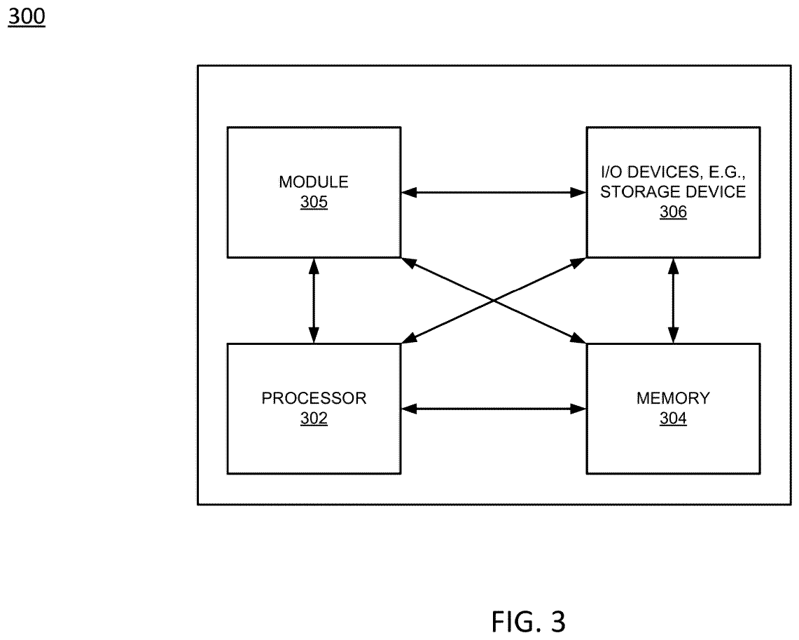

The AS 104 may comprise one or more physical devices, e.g., one or more computing systems or servers, such as computing system 300 depicted in FIG. 3, and may be configured as described below. It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 3 and discussed below) or multiple computing devices collectively configured to perform various steps, functions, and/or operations in accordance with the present disclosure. In one example, the DB 106 may comprise a physical storage device integrated with the AS 104 (e.g., a database server or a file server), or attached or coupled to the AS 104, in accordance with the present disclosure.

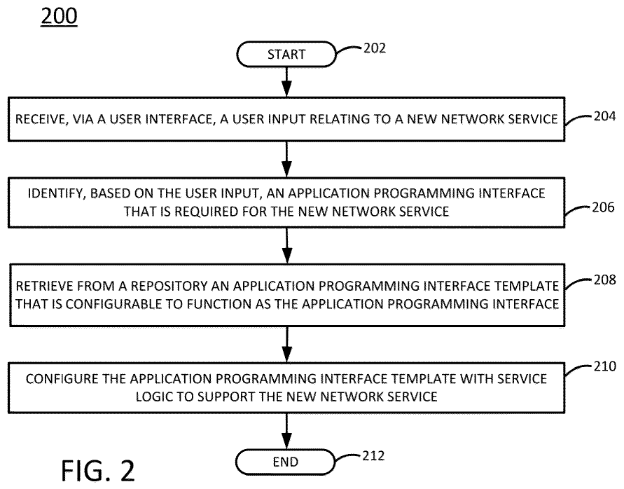

In one example, the AS 104 may load instructions into a memory, or one or more distributed memory units, and execute the instructions for automatically configuring application programming interfaces for network services, as described herein. For instance, an example method for automatically configuring application programming interfaces for network services is discussed in further detail below in connection with FIG. 2.

It should be noted that the system 100 has been simplified. Thus, those skilled in the art will realize that the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For example, the system 100 may include other network elements (not shown) such as border elements, routers, switches, policy servers, security devices, gateways, a content distribution network (CDN) and the like. For example, portions of the core network 102, access networks 120 and 122, and/or Internet 124 may comprise a content distribution network (CDN) having ingest servers, edge servers, and the like. Similarly, although only two access networks, 120 and 122 are shown, in other examples, access networks 120 and/or 122 may each comprise a plurality of different access networks that may interface with the core network 102 independently or in a chained manner. For example, user endpoint devices may communicate with the core network 102 via different access networks, and so forth. Thus, these and other modifications are all contemplated within the scope of the present disclosure.

To further aid in understanding the present disclosure, FIG. 2 illustrates a flowchart of an example method 200 for automatically configuring application programming interfaces for network services. In one example, the method 200 may be performed by the AS 104 or by another element of the core network 102 illustrated in FIG. 1 as part of a software development toolkit. However, in other examples, the method 200 may be performed by another device, such as the computing system 300 of FIG. 3, discussed in further detail below. For the sake of discussion, the method 200 is described below as being performed by a processing system (where the processing system may comprise a component of the AS 104 or by another element of the core network 102, the computing system 300, or another device).

The method 200 begins in step 202. In step 204, the processing system may receive, via a user interface, a user input relating to a new network service. In one example, the new network service may be a microservice, i.e., a variant of service-oriented architecture in which loosely coupled services are accessed through public APIs. The new network service may be offered by the party who operates the processing system or by a party other than the party who operates the processing system. For instance, the party who operates the processing system may comprise a communications network operator who operates a communications network via which subscribers may access various network-supported applications and services, such as streaming video applications, streaming music applications, gaming applications, augmented reality applications, health monitoring applications, banking and financial applications, and the like. The new network service may a service (or a feature of a service) of any of these types, or may be a service (or a feature of a service) of another type that will be accessible to subscribers of the communications network operator's services.

In one example, the user input may specify a type of the new network service (e.g., streaming video application, streaming music application, gaming application, augmented reality application, health monitoring application, banking or financial application, or the like). In a further example, the user input may specify a feature of the new network service that requires support of an application programming interface. For instance, the application programming interface may be required to allow a user of the new network service to access the feature of the new network service. As an example, the feature of the new network service may comprise an option to allow the user to request a lower latency network connection while using the new network service, or to allow the user to expose his or her current geographic location while using the new network service.

In step 206, the processing system may identify, based on the user input, an application programming interface that is required for the new network service. For instance, as discussed above, the application programming interface may be required to allow a user to access a feature of the new network service, such as an ability to request a lower latency network connection while using the new network service, or an ability to expose the user's current geographic location while using the new network service.

As an example, the new network service may be a service that allows a user, during an online gaming session, to temporarily “uplift” or upgrade the user's Quality of Service class identifier (QCI) to a QCI associated with lower network latency, which in turn may improve the user's gaming experience. To provide this ability to uplift the QCI for a gaming session, a server that supports the online gaming session may need to consume an application programming interface that communicates with a service provided by an operator of a communications network over which the user accesses the server. The application programming interface may be an application programming interface that interfaces to a subscription service offered by the operator of the communications network, where the subscription service may allow the user to select from multiple different tiers associated with different levels of service (e.g., different latencies, different bitrates for video content, etc.).

As another example, the new network service may be a service the allows a user, while present at a venue, to temporarily, uplift the user's QCI to a QCI associated with a lower network latency, which in turn may provide the user with more reliable access to information about an event currently taking place at the venue (e.g., a professional sporting event, a concert, a convention, or the like). To provide this ability to uplift the QCI during the event, a server that supports an application that provides event information may need to consume an application programming interface that communicates with a service provided by an operator of a communications network over which the user accesses the server. The application programming interface may be an application programming interface that interfaces to a subscription service offered by the operator of the communications network, where the subscription service may allow the user to select from multiple different tiers associated with different levels of service.

In one example, identifying the application programming interface may include identifying, and exposing to a user via the user interface, any application logic that calls the application programming interface. In other words, the processing system may identify the application logic for submitting requests to and/or retrieving requested data from the application programming interface. This application logic may include, for example, uniform resource identifiers (URIs) of any servers or external programs whose data may be used by the new network service, a nature of a request related to the data (e.g., GET, POST, PUT, DELETE, etc.), headers that convey information about requests to the application programming interface (e.g., a user-agent header, a content-type header, an accept header, or the like), a key or access token for authenticating calls to the application programming interface, and/or other application logic.

In step 208, the processing system may retrieve from a repository an application programming interface template that can be configured to function as the application programming interface. In one example, the processing system may have access to a repository of application programming interface templates, where each application programming interface template in the repository functions as an application programming interface enabler. At least one application programming interface template in the repository may comprise an application programming interface that has been used in an existing or previously offered network service. At least one other application programming interface template may comprise a generic template that can be configured with specific values to facilitate communications between specific applications or operating systems. Parameters of the application programming interface template may be configurable to support new features of the new network service.

For instance, in the QCI uplift for gaming example described above, the operator of the communications network may have previously developed the subscription service that allows users to select from multiple different tiers associated with different levels of service, and may have exposed an application programming interface that allows another application or operating system (such as the online gaming application) to communicate with the subscription service. Thus, the application programming interface template in this example may comprise a template that allows an application or operating system to communicate with the subscription service.

As another example, in the QCI uplift for event information described above, the application programming interface template may comprise a template that allows an application or operating system to communicate with the subscription service. The application programming interface template may further comprise a template that allows an application programming interface to invoke event and/or location monitoring services, so that the user's location can be confirmed to be within the venue (e.g., via location monitoring of the user's smart phone or another device), the event for which the information is provided can be confirmed to be in progress, and the like.

In step 210, the processing system may configure the application programming interface template with service logic to support the new network service. In one example, configuring the application programming interface with the service logic to support the new network service may comprise configuring a parameter of the application programming interface template with a value provided by a user. In one example, the user may provide the value via the user interface. For instance, the user interface may comprise a drag and drop style graphical user interface that allows the user to view one or more application programming interface templates and to provide values for configuring the features of at least one of the application programming interface templates.

In one example, configuring the application programming interface template with the service logic to support the new network service effectively orchestrates the application programming interface for service. That is, the configuring may involve integrating the application programming interface with other services and network assets, so that processes such as the transformation of requests and responses into different formats, the integration of legacy systems, the management of authorizations between services, and the like are automated. Thus, orchestration may include initiating processes for provisioning, service verification, application programming interface validation, event generation, syntax check, and other services required to support the new network service. These other services may be initiated by invoking existing building blocks for the other services (which may be available in the repository, or in another storage location).

In one example, configuring the application programming interface template with the service logic may include configuring a user interface component that allows users to access the new network service via the application programming interface. For instance, in the QCI uplift for gaming example described above, the user interface of the online gaming application may include a widget or another user interface component that a user can select (e.g., by clicking on, hovering over, or the like) to activate the new network service. In the QCI uplift for event information described above, the configuring may comprise ensuring that invocation of the application programming interface triggers a backend entitlement check (e.g., to confirm that the user's smart phone, a pair of smart eye glasses or goggles, or another device is compatible with or subscribed to services provided by a 5G network).

The method 200 may end in step 212.

Although not expressly specified above, one or more steps of the method 200 may include a storing, displaying, and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 that recite a determining operation or involve a decision do not necessarily require that both branches of the determining operation be practiced. In other words, one of the branches of the determining operation can be deemed as an optional step. Furthermore, operations, steps or blocks of the above described method(s) can be combined, separated, and/or performed in a different order from that described above, without departing from the examples of the present disclosure.

Thus, examples of the present disclosure may allow application programming interfaces to be reused by different building blocks of a software development toolkit. For instance, an operator of a 5G cellular network may develop a service that allows subscribers to temporarily uplift their data sessions on the 5G cellular network and may expose an application programming interface that facilitates session uplift in a repository of application programming interface templates. In one example, a game developer may include a widget in an online gaming application that, when selected by a user of the gaming application, causes a server that supports the gaming application to consume the application programming interface provided by the operator of the 5G cellular network. This, in turn, may direct the user to a user interface that allows the user to temporarily uplift their data session to support a better gaming experience while using the online gaming application. In another example, an operator of a venue that hosts events may partner with the operator of the 5G cellular network to provide subscribers of the 5G cellular network with exclusive event information for events taking place at the venue. For instance, a subscriber attending a concert at the venue may be able to access a venue seating chart, concessions information, concert setlists, or other information. When the subscriber launches an application on their smart phone, a pair of smart eye glasses or goggles, or another device, the application programming interface may invoke event and location monitoring to verify that the subscriber is currently physically present at the venue and that the concert is still in progress before uplifting the subscriber's data session so that the subscriber can reliably access the event information.

FIG. 3 depicts a high-level block diagram of a computing device specifically programmed to perform the functions described herein. For example, any one or more components or devices illustrated in FIG. 1 or described in connection with the method 200 may be implemented as the system 300. For instance, the AS 104 of FIG. 1 (such as might be used to perform the method 200) could be implemented as illustrated in FIG. 3. As depicted in FIG. 3, the system 300 comprises a hardware processor element 302, a memory 304, a module 305 for automatically configuring application programming interfaces for network services, and various input/output (I/O) devices 306.

The hardware processor 302 may comprise, for example, a microprocessor, a central processing unit (CPU), or the like. The memory 304 may comprise, for example, random access memory (RAM), read only memory (ROM), a disk drive, an optical drive, a magnetic drive, and/or a Universal Serial Bus (USB) drive. The module 305 for automatically configuring application programming interfaces for network services may include circuitry and/or logic for performing special purpose functions relating to optimizing query plans for SQL queries. The input/output devices 306 may include, for example, storage devices (including but not limited to, a tape drive, a floppy drive, a hard disk drive or a compact disk drive), a receiver, a transmitter, a fiber optic communications line, an output port, or a user input device (such as a keyboard, a keypad, a mouse, and the like).

Although only one processor element is shown, it should be noted that the computer may employ a plurality of processor elements. Furthermore, although only one specific-purpose computer is shown in the Figure, if the method(s) as discussed above is implemented in a distributed or parallel manner for a particular illustrative example, i.e., the steps of the above method(s) or the entire method(s) are implemented across multiple or parallel specific-purpose computers, then the specific-purpose computer of this Figure is intended to represent each of those multiple specific-purpose computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 305 for automatically configuring application programming interfaces for network services can be loaded into memory 304 and executed by hardware processor element 302 to implement the steps, functions or operations as discussed above in connection with the example method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 305 for automatically configuring application programming interfaces for network services (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

What is claimed is:

1. A method comprising:
receiving, by a processing system including at least one processor via a user interface, a user input relating to a new network service;
identifying, by the processing system based on the user input, an application programming interface that is required for the new network service;
retrieving, by the processing system from a repository, an application programming interface template that is configurable to function as the application programming interface; and
configuring, by the processing system, the application programming interface template with service logic to support the new network service.

2. The method of claim 1, wherein the user interface comprises an interface for a software development toolkit.

3. The method of claim 1, wherein the new network service is a microservice.

4. The method of claim 1, wherein the processing system is operated by an operator of a communications network over which the new network service will be accessed by users.

5. The method of claim 4, wherein the new network service comprises a service offered by the operator of the communications network.

6. The method of claim 4, wherein the new network service comprises a service offered by a party other than the operator of the communications network.

7. The method of claim 1, wherein the new network service comprises a feature of at least one of: a streaming video application, a streaming music application, a gaming application, an augmented reality application, a health monitoring application, a banking application, or a financial application.

8. The method of claim 1, wherein the user input specifies at least one of: a type of the new network service or a feature of the new network service that requires support of the application programming interface.

9. The method of claim 1, wherein the application programming interface template is configurable to support more than one type of network service including the new network service.

10. The method of claim 1, wherein the application programming interface template has previously been configured to generate an application programming interface that supports an existing network service.

11. The method of claim 1, wherein the identifying comprises identifying and exposing via the user interface an application logic that calls the application programming interface.

12. The method of claim 1, wherein the configuring comprises configuring a parameter of the application programming interface template with a value provided by a user.

13. The method of claim 1, wherein the configuring orchestrates the application programming interface for service.

14. A non-transitory computer-readable medium storing instructions which, when executed by a processing system including at least one processor, cause the processing system to perform operations, the operations comprising:
receiving, via a user interface, a user input relating to a new network service;
identifying, based on the user input, an application programming interface that is required for the new network service;
retrieving, from a repository, an application programming interface template that is configurable to function as the application programming interface; and
configuring the application programming interface template with service logic to support the new network service.

15. The non-transitory computer-readable medium of claim 14, wherein the user input specifies at least one of: a type of the new network service or a feature of the new network service that requires support of the application programming interface.

16. The non-transitory computer-readable medium of claim 14, wherein the new network service comprises a feature of at least one of: a streaming video application, a streaming music application, a gaming application, an augmented reality application, a health monitoring application, a banking application, or a financial application.

17. The non-transitory computer-readable medium of claim 14, wherein the application programming interface template has previously been configured to generate an application programming interface that supports an existing network service.

18. The non-transitory computer-readable medium of claim 14, wherein the processing system is operated by an operator of a communications network over which the new network service will be accessed by users.

19. The non-transitory computer-readable medium of claim 18, wherein the new network service comprises a service offered by a party other than the operator of the communications network.

20. A system comprising:
a processing system including at least one processor; and
a non-transitory computer-readable medium storing instructions which, when executed by the processing system, cause the processing system to perform operations, the operations comprising:
receiving, via a user interface, a user input relating to a new network service;
identifying, based on the user input, an application programming interface that is required for the new network service;
retrieving, from a repository, an application programming interface template that is configurable to function as the application programming interface; and
configuring the application programming interface template with service logic to support the new network service.
